(19) United States
(12) Patent Application Publication
(10) Pub. No.: US 2018/0362204 A1
(43) Pub. Date: Dec. 20, 2018

(54) Beverage Labeling Assembly

(71) Applicant: Frances Rivera, Lubbock, TX (US)

(72) Inventor: Frances Rivera, Lubbock, TX (US)

(21) Appl. No.: 15/624,807

(22) Filed: Jun. 16, 2017

(51) Int. Cl. B65C 11/00; G09F 3/10; B65D 83/08

(52) U.S. Cl. CPC B65C 11/004; G09F 2003/0273; B65D 83/0876; G09F 3/10

(57) ABSTRACT

A beverage labeling assembly for labeling a beverage container at a social gathering includes a dispenser that may be manipulated. A tape is releasably positioned within the dispenser and the tape is selectively drawn outwardly from the dispenser. A plurality of labels is provided and each of the labels is removably adhered to the tape. Each of the labels is attached to a beverage container thereby facilitating ownership of the beverage container to be established.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to labeling devices and more particularly pertains to a new labeling device for labeling a beverage container at a social gathering.

### BRIEF SUMMARY OF THE INVENTION

An embodiment of the disclosure meets the needs presented above by generally comprising a dispenser that may be manipulated. A tape is releasably positioned within the dispenser and the tape is selectively drawn outwardly from the dispenser. A plurality of labels is provided and each of the labels is removably adhered to the tape. Each of the labels is attached to a beverage container thereby facilitating ownership of the beverage container to be established.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a beverage labeling assembly according to an embodiment of the disclosure.

FIG. 2 is a left side view of an embodiment of the disclosure.

FIG. 3 is a top view of an embodiment of the disclosure.

FIG. 4 is a perspective in-use view of an embodiment of the disclosure.

FIG. 5 is a perspective view of an embodiment of the disclosure.

FIG. 6 is a front perspective in-use view of an embodiment of the disclosure.

FIG. 7 is a right side view of an embodiment of the disclosure.

### DETAILED DESCRIPTION OF THE INVENTION

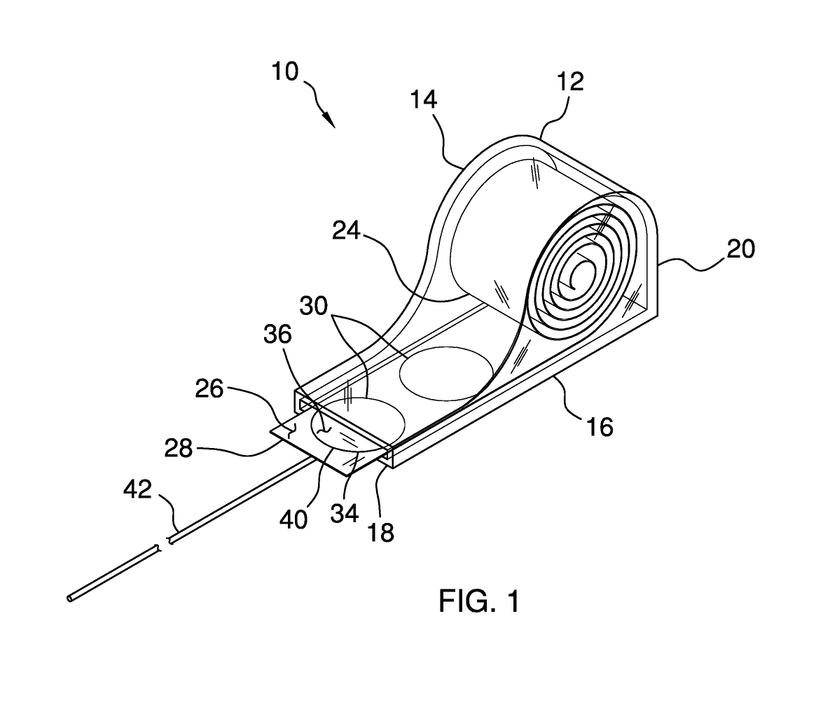

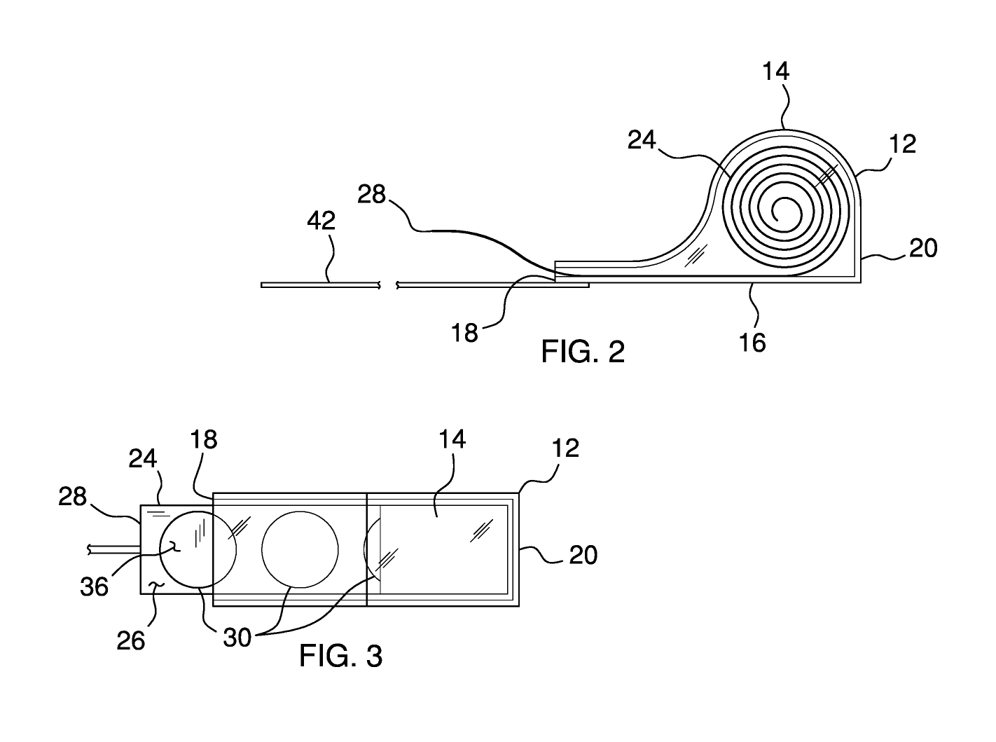

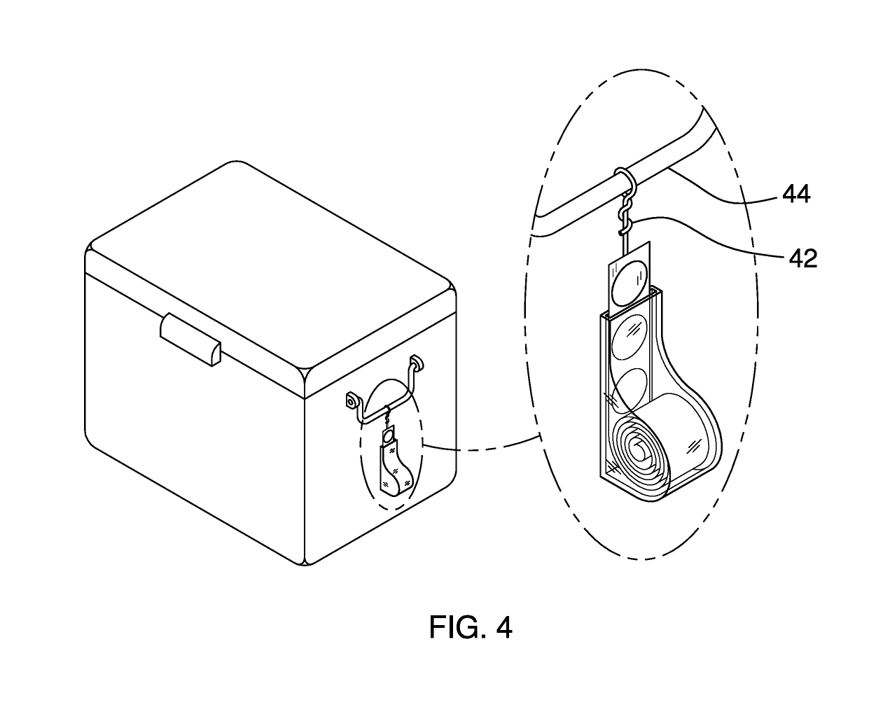

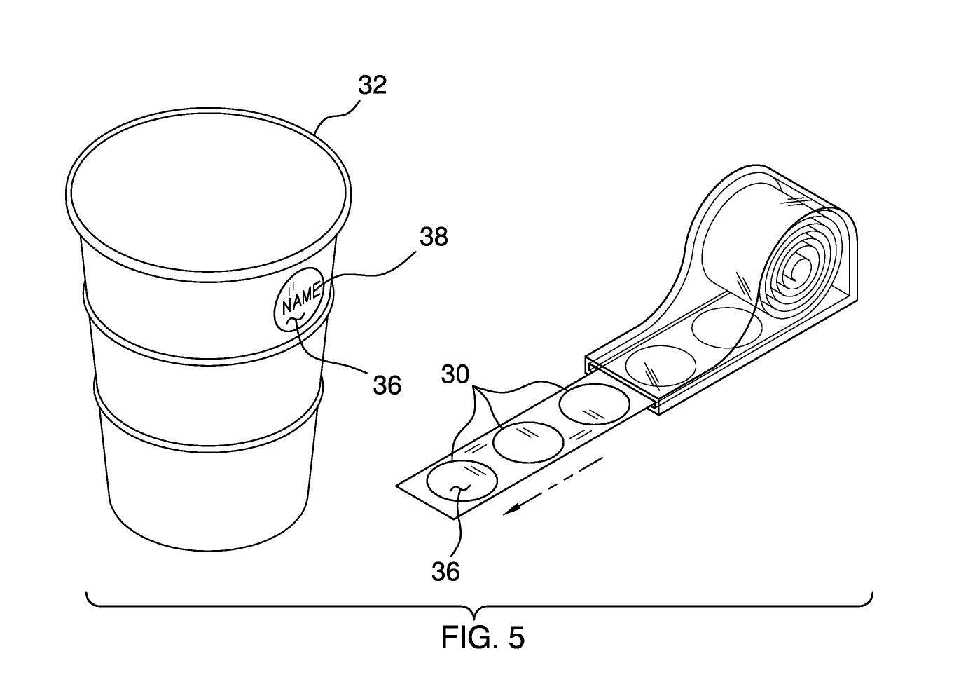

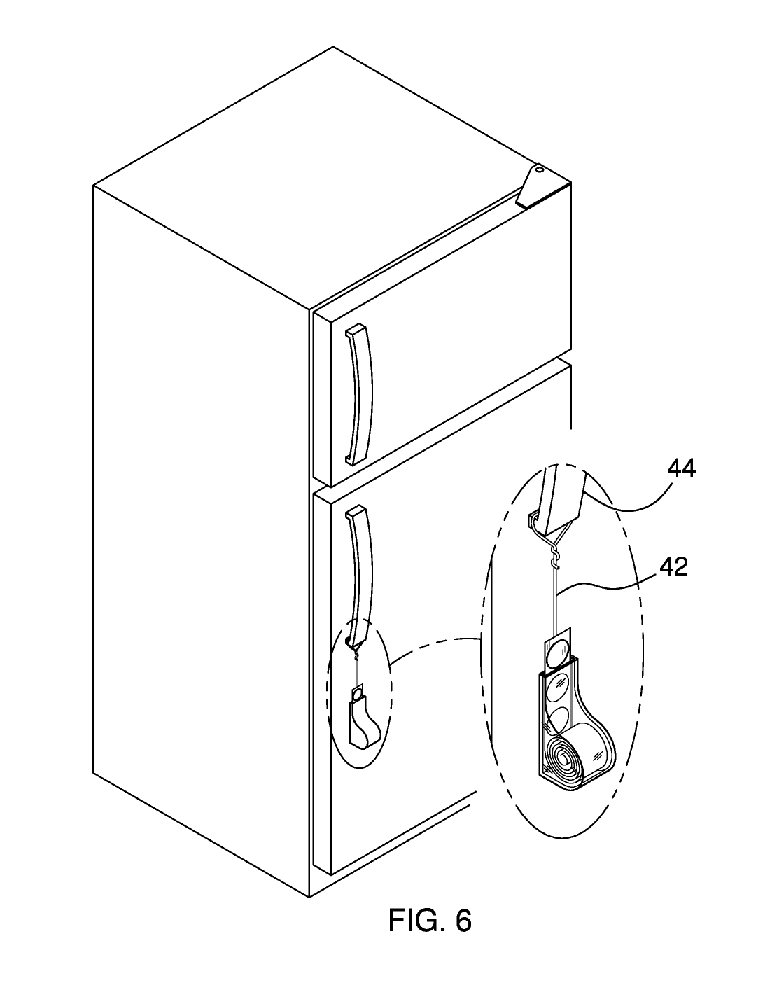

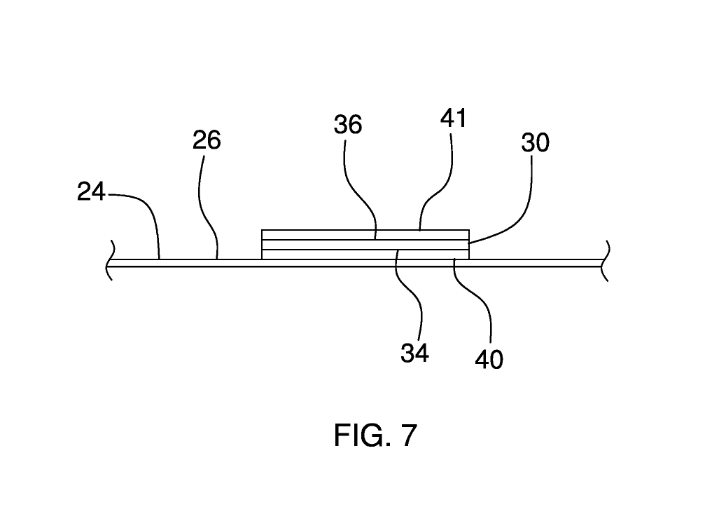

With reference now to the drawings, and in particular to FIGS. 1 through 7 thereof, a new labeling device embodying the principles and concepts of an embodiment of the disclosure and generally designated by the reference numeral 10 will be described.

As best illustrated in FIGS. 1 through 7, the beverage labeling assembly 10 generally comprises a dispenser 12 that may be manipulated. The dispenser 12 has a top wall 14, a bottom wall 16, a front side 18 and a back side 20. The top wall 14 curves downwardly toward the front side 18 to define a spout 22 on the front side 18. The front side 18 is open and the dispenser 12 is substantially hollow. The top wall 14 may be comprised of a translucent material such that an interior of the dispenser 12 is visible.

A tape 24 is provided and the tape 24 is releasably positioned within the dispenser 12. The tape 24 is rolled into itself in the dispenser 12 and the tape 24 has a top surface 26 and a free end 28. The free end 28 extends outwardly from the front side 18 to be selectively drawn outwardly from the dispenser 12.

A plurality of labels 30 is provided and each of the labels 30 is removably adhered to the tape 24 such that each of the labels 30 is selectively removed from the tape 24. Each of the labels 30 may be attached to a beverage container 32 thereby facilitating ownership of the beverage container 32 to be established. The beverage container 32 may be a cup, a bottle, a can or any other beverage container 32.

Each of the labels 30 has a first surface 34 and a second surface 36 and the second surface 36 is comprised of a pressure sensitive material. Thus, the second surface 36 changes color when the second surface 36 is frictionally engaged thereby facilitating indicia 38 to be selectively imprinted on the second surface 36. The indicia 38 may be a user's name or an image chosen by the user.

The labels 30 are spaced apart from each other and are distributed on the tape 24. Each of the labels 30 is comprised of a fluid impermeable material such as polyvinyl chloride or the like. Each of the labels 30 has an adhesive layer 40 that is positioned on the first surface 34 and the adhesive layer 40 removably engages the top surface 26 of the tape 24. The adhesive layer 40 adhesively engages the beverage material such that each of the labels 30 is retained on the beverage container 32. The adhesive may be a fluid resistant adhesive such that condensation on the beverage container 32 does not inhibit the adhesive from adhering to the beverage container 32.

Each of the labels 30 may include a protective sheet 41 that is coupled to the second surface 36 of the label 30. The protective sheet 41 completely covers the second surface 36 and the protective sheet 41 may be comprised of a translucent material. Moreover, the protective sheet 41 is comprised of a resilient material to resist being deformed by pressure that is less than a trigger pressure. In this way the protective sheet 41 inhibits the second surface 36 of the label 30 from being inadvertently frictionally engaged. The trigger pressure may be a pressure ranging between 2.0 grams and 4.0 grams. Thus, the second surface 36 of the label 30 changes color when the protective sheet 41 is exposed to a frictional pressure that is greater than the trigger pressure.

A lanyard 42 is coupled to and extends away from the front side 18 of the dispenser 12. The lanyard 42 is selectively wrapped around an object 44 thereby facilitating the dispenser 12 to be suspended from the object 44. The object 44 may be a beverage cooler, a table or any other object 44 commonly found at a social gathering involving the consumption of beverages. The lanyard 42 is comprised of a resiliently bendable material.

An adhesive strip may be coupled to the back side 20 of the dispenser 12. The adhesive strip may comprise double sided tape or the like and the adhesive strip may include a protective barrier. The protective barrier may be selectively removed and the adhesive strip may adhesively engage the object 44. A clip may be coupled to the back side 20 of the dispenser for engaging an article of clothing or the like. The clip may include a leg that is coupled to the back side 20 and a foot that is spaced from the back side 20.

In use, the free end 28 of the tape 24 is gripped and the tape 24 is urged outwardly from the dispenser 12. A selected one of the labels 30 is removed from the tape 24 and the selected label is adhered to the beverage container 32. The second surface 36 of the label is frictionally engaged with an object such as a fingernail or the like. The second surface 36 of the label reacts to the pressure of the object 44 and the second surface 36 changes color where the object 44 frictionally engages the second surface 36. Thus, ownership of the beverage container 32 is established with a name, image or any other indicia 38 chosen by the beverage owner. In this way the selected label 30 inhibits the beverage container 32 from being lost or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A beverage labeling assembly being configured to identify ownership of a beverage at a social gathering, said assembly comprising:
a dispenser being configured to be manipulated, said dispenser having a top wall, a bottom wall, a front side and a back side, said top wall curving downwardly toward said front side to define an elongated spout on said front side, said front side being open, said dispenser being substantially hollow, said bottom wall being planar;
a tape being releasably positioned within said dispenser wherein said tape is configured to be selectively drawn outwardly from said dispenser;
a plurality of labels, each of said labels being removably adhered to said tape wherein each of said labels is selectively removed from said tape, each of said labels being configured to be attached to a beverage container thereby facilitating ownership of the beverage container to be established; and
a lanyard being coupled to and extending away from said front side of said dispenser wherein said lanyard is configured to be wrapped around an object thereby facilitating said dispenser to be suspended from the object, said lanyard being comprised of a resiliently bendable material.

2. (canceled)

3. The assembly according to claim 1, further comprising said tape being rolled into itself in said dispenser, said tape having a top surface and a free end, said free end extending outwardly from said front side.

4. The assembly according to claim 1, wherein:
said tape has a top surface; and
each of said labels has a first surface and a second surface, said second surface being comprised of a pressure sensitive material wherein said second surface is configured to change color when said second surface is frictionally engaged thereby facilitating indicia to be selectively imprinted on said second surface, said labels being spaced apart from each other and being distributed on said top surface of said tape, each of said labels being comprised of a fluid impermeable material.

5. The assembly according to claim 4, wherein said first surface has an adhesive layer being positioned thereon, said adhesive layer removably engaging said top surface of said tape, said adhesive layer being configured to adhesively engage the beverage material such that each of said labels is retained on the beverage container.

6. (canceled)

7. A beverage labeling assembly being configured to identify ownership of a beverage at a social gathering, said assembly comprising:
a dispenser being configured to be manipulated, said dispenser having a top wall, a bottom wall, a front side and a back side, said top wall curving downwardly toward said front side to define an elongated spout on said front side, said front side being open, said dispenser being substantially hollow, said bottom wall being planar;
a tape being releasably positioned within said dispenser, said tape being rolled into itself in said dispenser, said tape having a top surface and a free end, said free end extending outwardly from said front side wherein said tape is configured to be selectively drawn outwardly from said dispenser;
a plurality of labels, each of said labels being removably adhered to said tape wherein each of said labels is selectively removed from said tape, each of said labels being configured to be attached to a beverage container thereby facilitating ownership of the beverage container to be established, each of said labels having a first surface and a second surface, said second surface being comprised of a pressure sensitive material wherein said second surface is configured to change color when said second surface is frictionally engaged thereby facilitating indicia to be selectively imprinted on said second surface, said labels being spaced apart from each other and being distributed on said tape, each of said labels being comprised of a fluid impermeable material, said first surface having an adhesive layer being positioned thereon, said adhesive layer removably engaging said top surface of said tape, said adhesive layer being configured to adhesively engage the beverage material such that each of said labels is retained on the beverage container; and
a lanyard being coupled to and extending away from said front side of said dispenser wherein said lanyard is configured to be wrapped around an object thereby facilitating said dispenser to be suspended from the object, said lanyard being comprised of a resiliently bendable material.
